(19) United States
(12) Patent Application Publication
(10) Pub. No.: US 2013/0299206 A1
(43) Pub. Date: Nov. 14, 2013

(54) HAMMER MECHANISM

(71) Applicants: Joachim Hecht, Magstadt (DE); Heiko Roehm, Stuttgart (DE); Martin Kraus, Filderstadt (DE)

(72) Inventors: Joachim Hecht, Magstadt (DE); Heiko Roehm, Stuttgart (DE); Martin Kraus, Filderstadt (DE)

(73) Assignee: Robert Bosch GMBH, Stuttgart (DE)

(21) Appl. No.: 13/989,247

(22) PCT Filed: Oct. 14, 2011
(86) PCT No.: PCT/EP11/67976

§ 371 Date: Aug. 5, 2013

(30) Foreign Application Priority Data
Nov. 29, 2010 (DE) 10 2010 062 107.2

(51) Int. Cl. B25D 17/08

(52) U.S. Cl. CPC B25D 17/084
USPC 173/104

(57) ABSTRACT

A hammer mechanism has a clamping chuck and a snap die provided for the direct striking of an inserted tool. The snap die includes a coupling element for transmitting a rotary motion to the clamping chuck.

### BACKGROUND OF THE INVENTION

1. Field of the Invention

The present invention relates to a hammer mechanism for a hand tool.

2. Description of the Related Art

A hammer mechanism including a clamping chuck and a snap die provided for the direct striking of an inserted tool are already known.

### BRIEF SUMMARY OF THE INVENTION

The present invention relates to a hammer mechanism which includes a clamping chuck and a snap die provided to directly strike an inserted tool.

It is proposed to equip the snap die with a coupling means for transmitting a rotary motion to the clamping chuck. The snap die advantageously transmits a rotary motion of a clamping chuck drive shaft to the clamping chuck. The term “clamping chuck” in particular describes a device for the direct mounting of an inserted tool in at least torsionally fixed manner, such that a user is able to be remove it, especially without employing a tool. A “snap die” in particular means an element of the hammer mechanism which during an impact-drilling operation transmits a strike pulse from the hammer means of the hammer mechanism in the direction of the inserted tool. In at least one operating state, the snap die preferably hits the inserted tool directly. The snap die preferably prevents dust from penetrating the hammer mechanism through the clamping chuck. “Provided” in particular means specially configured and/or equipped. An “inserted tool” in particular refers to a means that acts directly on a workpiece during a working step. In an operative state, the inserted tool preferably is connected to the clamping chuck, particularly in reversible manner without using a tool. “Coupling means” in particular describes a means for transmitting a motion from one component to another component through at least one keyed connection. The keyed connection preferably is developed in such a way that a user is able to release it in at least one operating state. In an especially preferred manner, the keyed connection is releasable for a switch between operating modes, i.e., advantageously between a screwing, drilling, cutting and/or an impact drilling operation. The coupling means in particular is developed in the form of a coupling considered useful by the expert, but advantageously as a dog clutch and/or toothing. The coupling means advantageously includes a plurality of keyed connection elements and a region that connects the keyed connection elements. The development according to the present invention makes it possible to provide an especially compact hammer mechanism.

In addition, the clamping chuck includes a coupling region for an inserted tool, with which region the coupling means of the snap die engages at least partially, so that an especially minimal construction outlay is achievable. A “coupling region for an inserted tool” in particular means a region of the clamping chuck whose form and dimensions in a plane perpendicular to an axis of rotation of the clamping chuck are the same as those of a region provided for the direct and torsionally fixed mounting of the inserted tool.

It is furthermore provided that the hammer mechanism includes a clamping chuck drive shaft to transmit a rotary motion to the snap die, so that an especially minimal space requirement is achievable by constructionally simple measures. Preferably, the clamping chuck drive shaft includes a coupling means, which in an operative state, produces a torsionally fixed and axially displaceable connection to a coupling means of the snap die. A “clamping chuck drive shaft” in particular denotes a shaft which during a drilling and/or impact drilling operation transmits a rotary motion from a gearing, especially a planetary gearing, in the direction of a clamping chuck. Preferably, the clamping chuck drive shaft is at least partially developed as solid shaft. The clamping chuck drive shaft preferably extends across at least 40 mm in the strike direction. In a drilling and/or impact drilling operation, the clamping chuck drive shaft and the clamping chuck preferably have the same rotational speed at all times, i.e., no gear unit is provided on a drive train between the clamping chuck drive shaft and the clamping chuck.

In one advantageous embodiment of the present invention, the clamping chuck drive shaft is at least partially situated within a recess of the snap die in at least one operating state, so that a compact and uncomplicated construction is possible.

In another development, the snap die includes a sealing region which rests against the clamping chuck without gear teeth and thereby makes it possible to achieve especially effective sealing from dust that may penetrate a coupling region of the inserted tool. A “sealing region” in particular means a region of the snap die that provides sealing from dust, contamination and moisture between the snap die and the clamping chuck. “Without gear teeth” in particular means that the sealing region in particular has no coupling means which transmits the rotary motion.

Furthermore, the hammer mechanism includes a strike means which is supported by the clamping chuck drive shaft in a manner allowing movement in the strike direction in at least one operating state, so that low weight and a small size are obtainable. A “strike means” in particular denotes a means of the hammer mechanism which is meant to be accelerated during operation by an impact-generation unit, especially in translatory fashion, and to output a pulse, picked up during the acceleration, in the direction of the inserted tool in the form of a strike pulse. The strike means preferably is supported by air pressure or, advantageously, by a rocker lever, in such a way that it is able to be accelerated in the strike direction. Prior to a strike, the strike means preferably is in a non-accelerated state. During a strike, the strike means outputs a strike pulse in the direction of the inserted tool, in particular via a snap die. A “strike direction” in particular denotes a direction that is oriented parallel to an axis of rotation of the clamping chuck and runs from the strike means in the direction of the clamping chuck. The strike direction preferably is aligned parallel to an axis of rotation of the clamping chuck drive shaft. The term “support so as to allow movement” specifically means that the clamping chuck drive shaft has a bearing surface which in at least one operating state transmits bearing forces to the strike means, in a direction perpendicular to the strike direction.

Furthermore, the clamping chuck drive shaft penetrates the strike means at least partially, so that a clamping chuck drive shaft having an especially low mass and requiring little space is able to be provided. The phrase “penetrates at least partially” in particular means that the strike means encloses the clamping chuck drive shaft over more than 270 degrees, advantageously 360 degrees, in at least one plane which advantageously is oriented perpendicularly to the strike direction. The strike means preferably is affixed on the clamping chuck drive shaft in form-fitting manner in a direction perpendicular to the axis of rotation of the clamping chuck drive shaft, i.e., mounted in a manner that allows movement in the direction of the axis of rotation.

Moreover, the hammer mechanism includes an impact-generation deactivation unit provided with a blocking element; this blocking element acts on the snap die, parallel to at least a force of the clamping chuck drive shaft, in at least a drilling and especially in a screwing operation, so that an advantageous placement of the operating element of the impact-generation deactivation unit is possible using constructionally uncomplicated measures. In particular, a circular operating element which encloses the snap die or the clamping chuck drive shaft is easy to realize. In addition, this development requires little space. An “impact-generation deactivation unit” in particular is a unit which allows an operator to deactivate the impact-generation unit for a drilling and/or screwing operation. Preferably, the impact-generation deactivation unit prevents an especially automatic activation of the impact-generation unit while an inserted tool is pressed against a workpiece in a drilling and/or screwing mode. The pressure application in a cutting and/or impact drilling mode preferably causes an axial displacement of the clamping chuck drive shaft. In an advantageous manner, the blocking element prevents an axial displacement of the clamping chuck drive shaft, the clamping chuck and/or advantageously, the snap die in the drilling and/or screwing mode. “Parallel to a force” in particular means that in at least one operating mode, the clamping chuck drive shaft and the blocking element apply a force to the snap die at two different locations. As an alternative or in addition, the clamping chuck drive shaft and the blocking element are able to exert a force on the clamping chuck at two different locations in at least one operating state. The forces preferably have a component aligned in the same direction, i.e., preferably parallel to the axis of rotation of the clamping chuck drive shaft, from the clamping chuck drive shaft in the direction of the clamping chuck. The blocking element preferably acts on the snap die directly, but especially preferably, at least by way of a clamping chuck bearing. Preferably, the clamping chuck drive shaft is acting on the snap die directly, and the snap die preferably transmits a rotary motion of the clamping chuck drive shaft to the clamping chuck.

In addition, the hammer mechanism includes a planetary gearing, which drives the clamping chuck drive shaft in at least one operating state, so that an advantageous translation is achievable in space-saving manner. Moreover, a torque restriction and a plurality of gear stages are realizable by simple design measures. A “planetary gearing” in particular means a unit having at least one planetary wheel set. A planetary wheel set preferably includes a sun gear, a ring gear, a planetary wheel carrier and at least one planetary wheel, which is guided along a circular path about the sun gear by the planetary wheel carrier. Preferably, the planetary gearing has at least two translation ratios between an input and an output of the planetary gearing, which are selectable by the operator.

In addition, the hammer tool includes an impact-generation unit as well as a coupling means which is connected to the clamping chuck drive shaft in torsionally fixed manner and drives the impact-generation unit, thereby realizing an especially compact and powerful hammer mechanism by employing constructionally uncomplicated measures. An “impact-generation unit” in particular describes a unit provided to translate a rotary motion into an especially translatory impact motion of the strike means suitable for a drilling or impact drilling operation. In particular, the impact-generation unit is developed as an impact-generation unit of the type considered useful by the expert, but preferably is implemented as a pneumatic impact-generation unit and/or, especially preferably, as an impact-generation unit having a rocker lever. A “rocker lever” in particular denotes a means which is mounted so as to allow movement about a pivot axis and which is provided to output power that has been picked up in a first coupling area, to a second coupling area. “In torsionally fixed manner” in particular means that the coupling means and the clamping chuck drive shaft are fixedly connected to each other in at least the circumferential direction, preferably in all directions, i.e., especially in all operating states. “Drive” in this context in particular means that the coupling means transmits kinetic energy, in particular rotational energy, to at least one region of the impact-generation unit. The impact-generation unit preferably uses this energy to drive the strike means. Because of the development according to the present invention, it is possible.

In addition, the hammer mechanism includes at least one bearing, which mounts the clamping chuck drive shaft in axially displaceable manner, thereby providing a simple means for deactivating the hammer mechanism. A “bearing” in this context specifically describes a device which mounts the clamping chuck drive shaft, especially in relation to a housing, in a manner that allows movement about the axis of rotation and an axial displacement. The phrase “axial displacement” in particular means that the bearing mounts the clamping chuck drive shaft is movable manner, especially relative to a housing, in a direction parallel to the strike direction. Preferably, a connection of the coupling means of the clamping chuck drive shaft driving the impact-generation unit is able to be severed by shifting the clamping chuck drive shaft in the axial direction.

Furthermore, the hammer mechanism includes a torque-restriction device for restricting a torque which is maximally transmittable via the clamping chuck drive shaft; this advantageously protects the operator, and the handheld tool is able to be used in a comfortable and safe manner for performing screwing operations. “Restrict” in this case in particular means that the torque-restriction device prevents an exceeding of the maximum torque adjustable by an operator. Preferably, the torque-restriction device opens a connection between a drive motor and the clamping chuck that is torsionally fixed during operation. As an alternative or in addition, the torque-restriction device may act on an energy supply of the drive motor.

It is furthermore provided that the impact-generation unit includes a spur gear transmission stage, which translates a rotational speed of the clamping chuck drive shaft into a higher rotational speed for an impact generation, thereby making it possible to achieve an especially advantageous ratio between the rotational speed and number of impacts of an inserted tool, in a space-saving and uncomplicated manner. A “spur-gear transmission stage” in particular denotes a system of especially two toothed wheel works engaging with one another, which are mounted so as to be rotatable about parallel axes. On a surface facing away from their axis, the toothed wheel works preferably have gear teeth. A “rotational speed for impact generation” in particular is a rotational speed of a drive means of the impact-generation unit that appears useful to the expert and which translates a rotary motion into a linear motion. The drive means of the impact-generation unit preferably is developed in the form of a wobble bearing or, especially preferably, as an eccentric element. “Translate” in this case means that there is a difference between the rotational speed of the clamping chuck drive shaft and the rotational speed for an impact generation. The rotational speed for the impact generation preferably is higher, advantageously at least twice as high as the rotational speed of the clamping chuck drive shaft. Especially preferably, a translation ratio between the rotational speed for impact generation and the rotational speed of the clamping chuck drive shaft is a non-integer ratio.

Moreover, a handheld tool is provided which includes a hammer mechanism according to the present invention. A “handheld tool” in this context in particular describes a handheld tool that appears useful to the expert, but preferably is a drilling machine, an impact drill, a screw driller, a boring tool and/or an impact drilling machine. The handheld tool preferably is developed as a battery-operated handheld tool, i.e., the handheld tool in particular includes coupling means provided to supply a drive motor of the handheld tool with electrical energy from a handheld tool battery pack connected to the coupling means.

### BRIEF DESCRIPTION OF THE DRAWINGS

FIG. 1 shows a perspective view of a handheld tool having a hammer mechanism according to the present invention.

FIG. 2 shows a section of the hammer mechanism of FIG. 1.

FIG. 3 shows coupling means, a clamping chuck drive shaft, a snap die, and a portion of a clamping chuck of the hammer mechanism from FIG. 1, shown individually in a perspective view in each case.

FIG. 4 shows another part-sectional view of the hammer mechanism from FIG. 1, which shows an impact-generation deactivation unit of the hammer mechanism.

FIG. 5 shows a schematic representation of a first alternative exemplary embodiment of a snap die of the hammer mechanism from FIG. 1.

FIG. 6 shows a schematic representation of a second alternative exemplary embodiment of a snap die of the hammer mechanism from FIG. 1.

FIG. 7 shows a sectional view of a third alternative exemplary embodiment of a snap die of the hammer mechanism from FIG. 1.

FIG. 8 shows a first perspective view of the snap die from FIG. 7.

FIG. 9 shows a second perspective view of the snap die from FIG. 7.

FIG. 10 shows a perspective view of a portion of a clamping chuck of the hammer mechanism of FIG. 7.

FIG. 11 shows a schematic representation of a fourth alternative exemplary embodiment of a snap die of the hammer mechanism from FIG. 1.

### DETAILED DESCRIPTION OF THE INVENTION

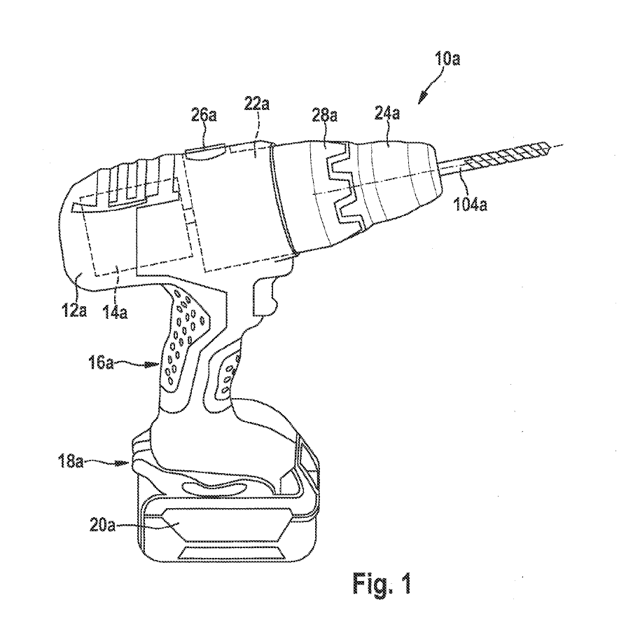

FIG. 1 shows a handheld tool 10a, which is developed as impact drill screwier. Handheld tool 10a has a pistol-shaped housing 12a. A drive motor 14a of handheld tool 10a is situated inside housing 12a. Housing 12a has a handle region 16a and a battery coupling means 18a, which is disposed at an end of handle region 16a facing away from drive motor 14a. Battery coupling means 18a links a handheld tool rechargeable battery 20a, which link is able to be severed by an operator, electrically or mechanically. Handheld tool battery 20a has an operating voltage of 10.8 Volt, but could also have a different operating voltage, especially a higher voltage. Furthermore, handheld tool 10a is provided with a hammer mechanism 22a according to the present invention, which includes a clamping chuck 24a disposed on the outside, and operating elements 26a, 28a.

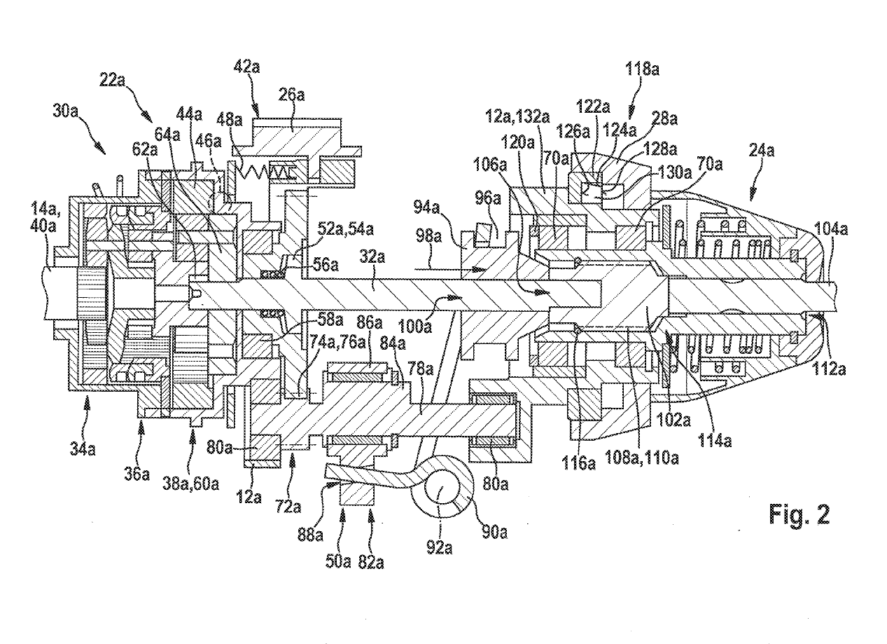

FIG. 2 shows hammer mechanism 22a in a sectional view. Hammer mechanism 22a also includes a planetary gearing 30a and a clamping chuck drive shaft 32a. When in operation, planetary gearing 30a drives clamping chuck drive shaft 32a so that it executes rotary motions about an axis of rotation. Planetary gearing 30a has three planetary gear stages 34a, 36a, 38a for this purpose. The transmission ratio of planetary gearing 30a between a rotor 40a of drive motor 14a and a clamping chuck drive shaft 32a is adjustable in at least two stages by an operator. As an alternative, a transmission ratio between drive motor 14a and clamping chuck drive shaft 32a could also be designed to be non-adjustable.

Hammer mechanism 22a has a torque restriction device 42a, which fixates a ring gear 44a of planetary gearing 30a during a working operation. Torque restriction device 42a is provided with fixation balls 46a for this purpose, which engage with recesses of ring gear 44a. A spring 48a of torque restriction device 42a exerts a force in the direction of ring gear 44a on fixation balls 46a. Using one of operating elements 26a, the operator is able to move an end of spring 48a facing fixation balls 46a in the direction of fixation balls 46a. Operating element 26a includes an eccentric element for this purpose. The force acting on fixation balls 46a thus is adjustable. If a particular maximum torque has been reached, fixation balls 46a are pushed out of the recesses and ring gear 44a runs freely, thereby interrupting a force transmission between rotor 40a and clamping chuck drive shaft 32a. Torque restriction device 42a thus is provided to restrict a maximum torque that is transmittable via clamping chuck drive shaft 32a.

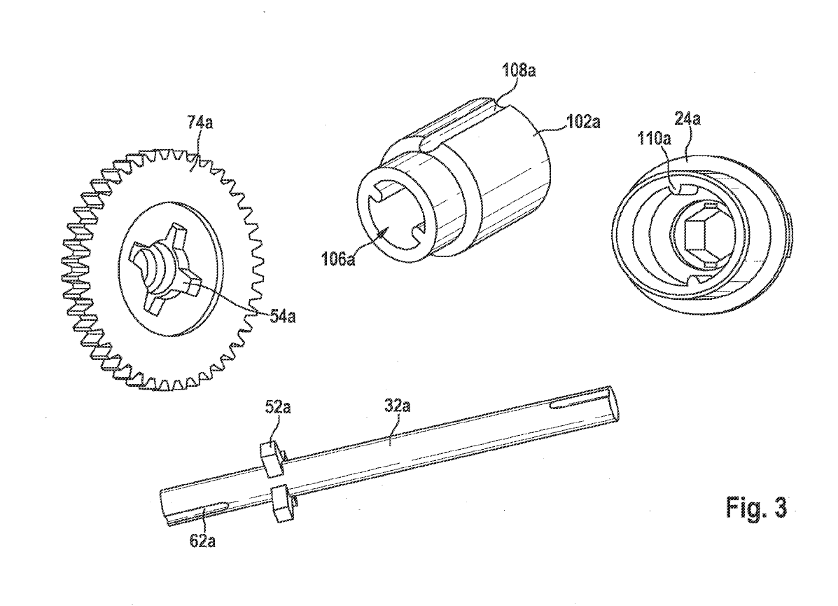

Hammer mechanism 22a includes an impact-generation unit 50a and first coupling means 52a. First coupling means 52a is connected to clamping chuck drive shaft 32a in torsionally fixed manner, i.e., first coupling means 52a and clamping chuck drive shaft 32a are formed in one piece, in particular. Impact-generation unit 50a includes a second coupling means 54a, which is connected to first coupling means 52a in torsionally fixed manner in a drilling and/or impact drilling mode. As shown in FIG. 3 as well, first coupling means 52a is developed as premolded shape and second coupling means 54a is developed as recess. When the drilling mode is activated, first coupling means 52a dips into second coupling means 54a, i.e., to the full extent. As a result, the coupling between first coupling means 52a and second coupling means 54a is reversible by axial shifting of clamping chuck drive shaft 32a in the direction of clamping chuck 24a. A spring 56a of hammer mechanism 22a is situated between first coupling means 52a and second coupling means 54a. Spring 56a pushes clamping chuck drive shaft 32a in the direction of clamping chuck 24a. When impact-generation unit 50a is deactivated, it opens the link between first coupling means 52a and second coupling means 54a.

Hammer mechanism 22a is provided with a first bearing 58a, which fixates second coupling means 54a relative to housing 12a in the axial direction and rotationally mounts it coaxially with clamping chuck drive shaft 32a. Furthermore, hammer mechanism 22a is provided with a second bearing 60a, which rotationally mounts clamping chuck drive shaft 32a on a side facing drive motor 14a, so that it is able to rotate about the axis of rotation. Second bearing 60a is integrally formed with one of the three planetary gear stages 38a. Clamping chuck drive shaft 32a has a coupling means 62a, which connects it to a planet carrier 64a of this planetary gear stage 38a in axially displaceable and torsionally fixed manner. This planetary gear stage 38a consequently is provided to mount clamping chuck drive shaft 32a in axially displaceable manner. On a side facing clamping chuck 24a, a clamping chuck bearing rotationally mounts clamping chuck drive shaft 32a together with clamping chuck 24a. Clamping chuck bearing 70a includes a rear bearing element which is pressed onto clamping chuck 24a in axially fixated manner. In addition, clamping chuck bearing 70a has a front bearing element which supports clamping chuck 24a inside housing 12a in axially displaceable manner.

Impact-generation unit 50a is equipped with a spur gear transmission stage 72a, which translates a rotational speed of clamping chuck drive shaft 32a into a higher rotational speed for the impact generation. A first toothed wheel 74a of spur gear transmission stage 72a is integrally formed with second coupling means 54a. In an impact-drilling operation, it is driven by clamping chuck drive shaft 32a. A second toothed wheel 76a of spur gear transmission stage 72a is integrally formed with a hammer mechanism shaft 78a. An axis of rotation of hammer mechanism shaft 78a is situated next to the axis of rotation of clamping chuck drive shaft 32a in the radial direction. Impact-generation unit 50a includes two bearings 80a, which mount hammer mechanism shaft 78a in axially fixated, rotatable manner. Impact-generation unit 50a is provided with a drive means 82a, which translates a rotary motion of hammer mechanism shaft 78a into a linear motion. An eccentric element 84a of drive means 82a is integrally formed with hammer mechanism shaft 78a. An eccentric sleeve 86a of drive means 82a is mounted on eccentric element 84a with the aid of a needle roller bearing, in a manner that allows it to rotate relative to eccentric element 84a. Eccentric sleeve 86a has a recess 88a, which encloses a rocker lever 90a of impact-generation unit 50a.

Rocker lever 90a is pivotably mounted on a pivot axle 92a of impact-generation unit 50a, that is to say, it is able to pivot about an axis aligned perpendicularly to the axis of rotation of clamping chuck drive shaft 32a. An end of rocker lever 90a facing away from drive means 82a partially encloses a strike means 94a of hammer mechanism 22a. In so doing, the rocker lever engages in a recess 96a of strike means 94a, which is developed in the form of a ring. In an impact-drilling operation, rocker lever 90a exerts a force on strike means 94a, which accelerates it. While in operation, rocker lever 90a moves in a sinusoidal pattern. Rocker lever 90a has an elastic form. It has a spring constant between eccentric sleeve 86a and strike means 94a that is less than 100 N/mm and greater than 10 N/mm. In this exemplary embodiment, rocker lever 90a has a spring constant of approximately 30 N/mm.

Clamping chuck drive shaft 32a mounts strike means 94a so that it is movable in strike direction 98a. To do so, strike means 94a delimit a recess 100a. Clamping chuck drive shaft 32a penetrates strike means 94a through recess 100a. In so doing, strike means 94a encloses recess 100a over 360 degrees in a plane perpendicular to recess 100a. When operated, strike means 94a strikes a snap die 102a of hammer mechanism 22a, which is situated between an inserted tool 104a and strike means 94a. In an operative state, inserted tool 104a is fixed in place inside clamping chuck 24a. Clamping chuck 24a mounts snap die 102a in a manner that allows it to move parallel to strike direction 98a. In an impact-drilling operation, strike pulses originating from strike means 94a are transmitted to inserted tool 104a by snap die 102a.

Clamping chuck drive shaft 32a is connected to snap die 102a in axially movable and torsionally fixed manner. Snap die 102a delimits a recess 106a for this purpose. In an operative state, clamping chuck drive shaft 32a is partially situated inside recess 106a of snap die 102a. Clamping chuck drive shaft 32a is rotationally mounted via snap die 102a, clamping chuck 24a and clamping chuck bearing 70a. Clamping chuck 24a is driven in rotating manner via snap die 102a. For this purpose, clamping chuck 24a and snap die 102a each include coupling means 108a, 110a, which are provided to transmit the rotary motion to clamping chuck 24a. Coupling means 108a of snap die 102a is developed as a groove, whose main extension is situated parallel to strike direction 98a. Coupling means 108a extends along a radially outward-lying surface area of snap die 102a. Coupling means 110a of clamping chuck 24a is implemented as a protrusion that fits the groove.

Clamping chuck 24a includes an inserted-tool coupling region 112a, in which inserted tool 104a is fixated in strike direction 98a during a drilling or screwing operation, or in which it is mounted so as to allow movement in strike direction 98a during an impact-drilling operation. In addition, the clamping chuck includes a tapered region 114a, which delimits a movement range of snap die 102a in strike direction 98a. Furthermore, clamping chuck 24a is provided with a mounting ring 116a, which delimits a movement range of snap die 102a counter to strike direction 98a.

During an impact-drilling operation, an operator presses inserted tool 104a against a workpiece (not shown further). The operator thereby shifts inserted tool 104a, snap die 102a and clamping chuck drive shaft 32a relative to housing 12a in a direction counter to the strike direction 98a, i.e., in the direction of drive motor 14a. In so doing, the operator compresses spring 56a of hammer mechanism 22a. First coupling means 52a dips into second coupling means 54a, so that clamping chuck drive shaft 32a begins to drive impact-generation unit 50a. When the operator stops pressing inserted tool 104a against the workpiece, spring 56a shifts clamping chuck drive shaft 32a, snap die 102a and inserted tool 104a in strike direction 98a. This releases a torsionally fixed connection between first coupling means 52a and second coupling means 54a, so that impact-generation unit 50a is switched off.

Hammer mechanism 22a has an impact-generation deactivation unit 118a, which includes a blocking element 120a, a sliding block guide 122a, and operating element 28a. In a drilling or screwing mode, blocking element 120a exerts a force on snap die 102a, which acts on snap die 102 parallel to at least a force of clamping chuck drive shaft 32a. The force of blocking element 120a is acting on snap die 102a via clamping chuck bearing 70a, clamping chuck 24a, and mounting ring 116a. The force of blocking element 120a prevents an axial displacement of snap die 102a and clamping chuck drive shaft 32a during a drilling and screwing mode, and thus prevents an activation of impact-generation unit 50a. The force of clamping chuck drive shaft 32a has a functionally parallel component which drives snap die 102a in rotating fashion during operation. In addition, the force has a functionally and directionally parallel component which spring 56a exerts on snap die 102a via clamping chuck drive shaft 32a.

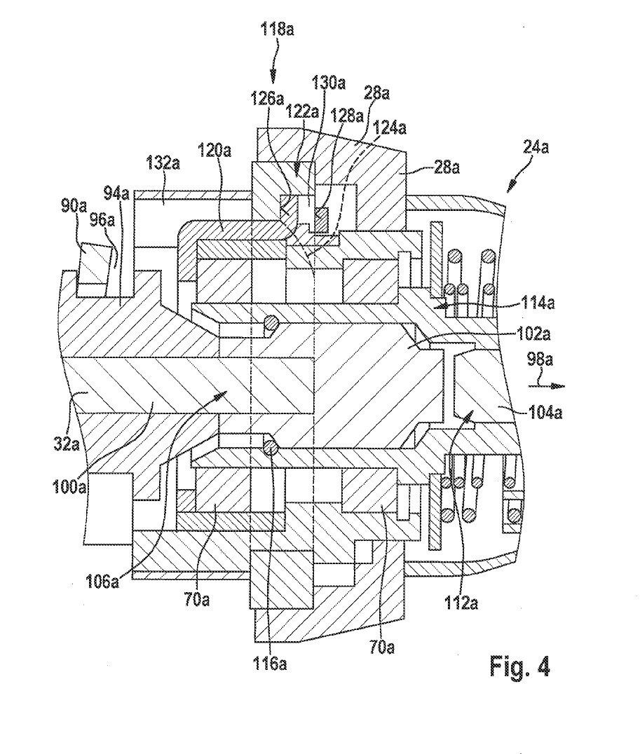

FIG. 4 shows a section that runs perpendicularly to the section of FIG. 2 and parallel to strike direction 98a, operating element 28a being shown in two different positions in the sections of FIGS. 2 and 4. Operating element 28a is developed in the form of a ring and encloses the axis of rotation of clamping chuck drive shaft 32a in coaxial manner. Operating element 28a is mounted so as to be rotatable. It is connected to sliding block guide 122a in torsionally fixed manner. Sliding block guide 122a is likewise developed in the form of a ring. Sliding block guide 122a has a bevel 124a, which connects two surfaces 126a, 128a of sliding block guide 122a, Surfaces 126a, 128a are aligned perpendicularly to strike direction 98a. Surfaces 126a, 128a are disposed in different planes in strike direction 98a.

In an impact-drilling mode, blocking element 120a is situated inside a recess 130a, which, for one, is delimited by bevel 124a and one of surfaces 126a. This surface 126a is situated closer to drive motor 14a than the other surface 128a. Housing 12a includes a housing element 132a, which mounts the blocking element in torsionally fixed manner and allows it move in strike direction 98a. At the start of an impact-drilling operation, blocking element 120a, together with clamping chuck 24a, therefore is able to be pushed in a direction counter to the strike direction 98a. In an impact-drilling operation, blocking element 120a does not exert a blocking force on clamping chuck 24a. When operating element 28a of impact-generation deactivation unit 118a is rotated, blocking element 120a is moved in strike direction 98a by bevel 124a.

In the drilling or screwing mode, blocking element 120a is kept in this frontal position. In this way blocking element 120a prevents axial shifting of clamping chuck drive shaft 32a in the drilling or screwing mode.

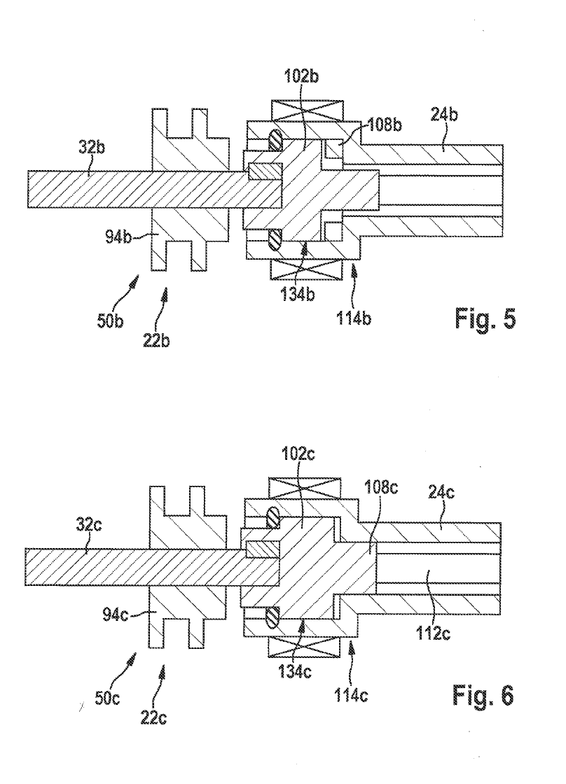

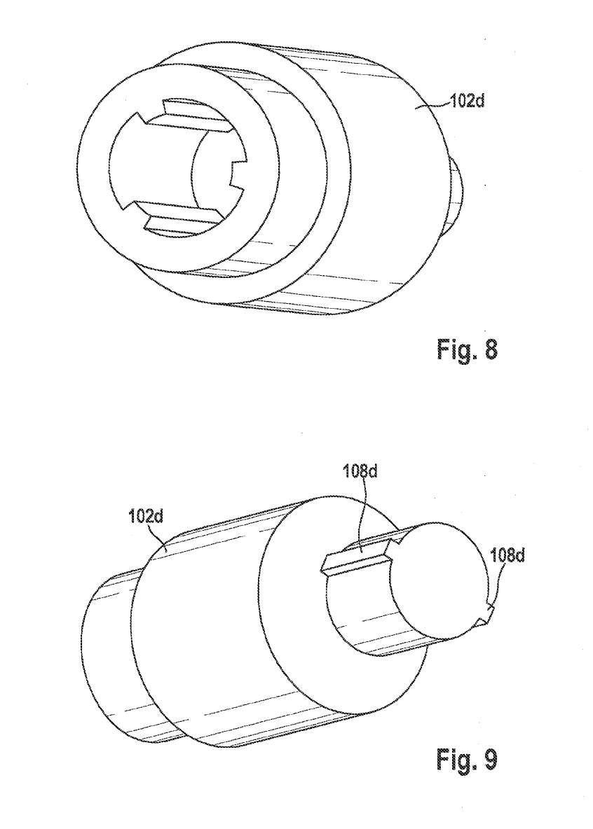

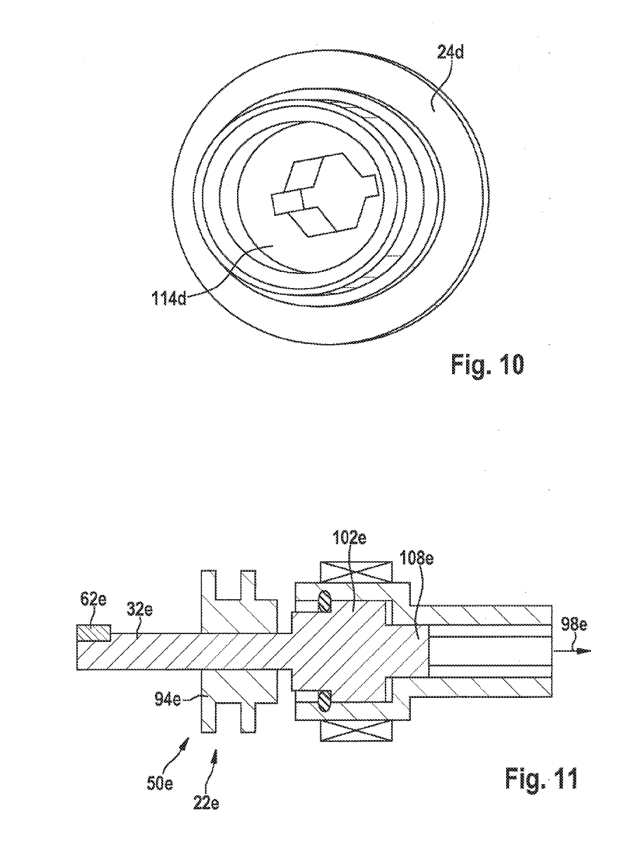

FIGS. 5 through 11 show additional exemplary embodiments of the present invention. The following descriptions and the figures are essentially limited to the differences between the exemplary embodiments. Regarding components designated in the same way, particularly regarding components bearing identical reference numerals, it is basically possible to refer also to the drawings and/or the description of the other exemplary embodiments, especially of FIGS. 1 through 4. In order to distinguish the exemplary embodiments, the letter a has been added after the reference numerals of the exemplary embodiment in FIGS. 1 through 4. In the exemplary embodiments of FIGS. 5 through 11, the letter a was replaced by the letters b through e.

FIG. 5 shows a portion of a hammer mechanism 22b. A hammer means 94b of an impact-generation unit 50b of hammer mechanism 22b is mounted in movable manner on a clamping chuck drive shaft 32b of hammer mechanism 22b. Clamping chuck drive shaft 32b is joined to a snap die 102b of hammer mechanism 22b in torsionally fixed and axially displaceable manner. Snap die 102b is provided with a coupling means 108b which forms a torsionally fixed connection to a clamping chuck 24b of hammer mechanism 22b in at least one operating state. Coupling means 108b is situated on a side that is facing a tapered region 114b of clamping chuck 24b and developed as teething. A sealing region 134b of the snap die is resting against clamping chuck 24b without gear teeth and advantageously prevents dust from entering impact-generation unit 50b.

FIG. 6, like FIG. 5, schematically illustrates a portion of hammer mechanism 22c. A hammer means 94c of an impact-generation unit 50c of hammer mechanism 22c is mounted in movable manner on a clamping chuck drive shaft 32c of hammer mechanism 22c. Clamping chuck drive shaft 32c is joined to a snap die 102b of hammer mechanism 22c in torsionally fixed and axially displaceable manner. Snap die 102c includes a coupling means 108c which forms a torsionally fixed connection to a clamping chuck 24c of hammer mechanism 22c in at least one operating state. Clamping chuck 24c is provided with an inserted-tool coupling region 112c, with which coupling means 108c of snap die 102c engages at least partially. The one inserted-tool coupling region 112c is provided to apply forces on an inserted tool in the peripheral direction during operation. In an operative state, coupling means 108c is at least partially disposed inside a tapered region 114c of clamping chuck 24c. Coupling means 108c is developed in the form of an external hexagon. The dimensions of the external hexagon correspond to the usual dimensions of a bit for a screwing operation. A sealing region 134c of the snap die 102c rests against clamping chuck 24c without gear teeth and advantageously prevents dust from entering impact-generation unit 50b in a cost-effective manner. Especially fat loss is able to be minimized.

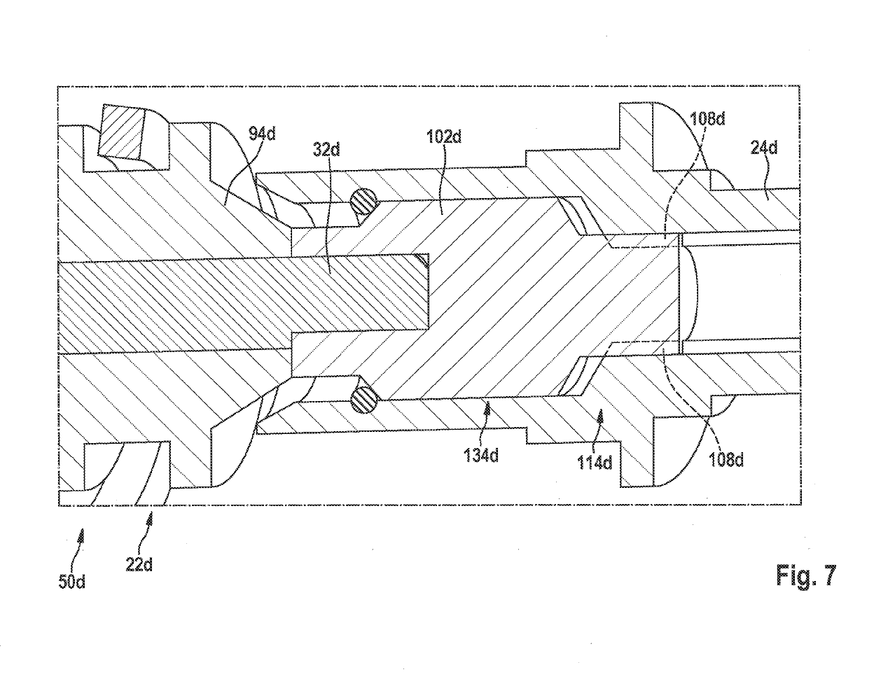

FIGS. 7 through 10 also show a portion of a hammer mechanism 22d as a section and in a perspective view. A hammer means 94d of an impact-generation unit 50d of hammer mechanism 22d is mounted in movable manner on a clamping chuck drive shaft 32d of hammer mechanism 22d. Clamping chuck drive shaft 32d is joined to a snap die 102d of hammer mechanism 22d in torsionally fixed and axially displaceable manner. Snap die 102d includes a coupling means 108d, which forms a torsionally fixed connection to a clamping chuck 24d of hammer mechanism 22d in at least one operating state. In an operative state, coupling means 108d is at least partially disposed inside a tapered region 114d of clamping chuck 24d. Coupling means 108d is developed as teething, which includes two coupling ribs that lie opposite each other in relation to the axis of rotation. Coupling means 108d has the same form and the same dimensions as a coupling means for the coupling with an inserted tool. The form and the dimensions correspond to those of the SDS Quick standard. A sealing region 134d of snap die 102d rests against clamping chuck 24d without gear teeth.

FIG. 11, like FIG. 5, schematically illustrates a portion of hammer mechanism 22e. A hammer means 94e of an impact-generation unit 50e of hammer mechanism 22e is movably mounted on a clamping chuck drive shaft 32e of hammer mechanism 22e. Clamping chuck drive shaft 32e is joined to a snap die 102e of hammer mechanism 22e in torsionally and axially fixed manner. Clamping chuck drive shaft 32e and snap die 102e are developed in one piece. In an impact, hammer means 94e moves both clamping chuck drive shaft 32e and snap die 102e in strike direction 98e. With the aid of a coupling means 62e, clamping chuck drive shaft 32e is connected in axially displaceable and torsionally fixed manner to a planetary-gear stage described in the exemplary embodiment of FIGS. 1 through 4.

1-11. (canceled)

12. A hammer mechanism of an apparatus, the hammer mechanism being configured for striking a tool inserted into the apparatus, comprising:
a clamping chuck; and
a snap die configured to directly strike the inserted tool, wherein the snap die includes a coupling element for transmitting a rotary motion to the clamping chuck.

13. The hammer mechanism as recited in claim 12, wherein the clamping chuck includes an inserted-tool coupling region with which the coupling element of the snap die engages at least partially.

14. The hammer mechanism as recited in claim 13, further comprising:
a clamping chuck drive shaft for transmitting a rotary motion to the snap die.

15. The hammer mechanism as recited in claim 14, wherein the clamping chuck drive shaft is at least partially disposed in a recess of the snap die in at least one operating state.

16. The hammer mechanism as recited in claim 13, wherein the snap die includes a sealing region which rests against the clamping chuck without gear teeth.

17. The hammer mechanism as recited in claim 14, further comprising:
a hammer element which is mounted by the clamping chuck drive shaft in a manner allowing movement in a strike direction in at least one operating state.

18. The hammer mechanism as recited in claim 17, wherein the clamping chuck drive shaft at least partially penetrates the hammer element.

19. The hammer mechanism as recited in claim 14, further comprising:
an impact-generation deactivation unit having a blocking element which acts on the snap die parallel to a force of the clamping chuck drive shaft, in at least a drilling operation.

20. The hammer mechanism as recited in claim 14, further comprising:
a planetary gearing which drives the clamping chuck drive shaft in at least one operating state.

21. The hammer mechanism as recited in claim 14, further comprising:
an impact-generation unit; and
a coupling element which is connected to the clamping chuck drive shaft in a torsionally-fixed manner and drives the impact-generation unit.

22. A hand-held tool, comprising:
an inserted tool element; and
a hammer mechanism having a clamping chuck and a snap die configured to directly strike the inserted tool element, wherein the snap die includes a coupling element for transmitting a rotary motion to the clamping chuck.
